(19) United States
(12) Patent Application Publication
(10) Pub. No.: US 2008/0098610 A1
(43) Pub. Date: May 1, 2008

(54) Measurement marker

(76) Inventor: Daniel Lipps, Virginia Beach, VA (US)

Correspondence Address: STEPHEN E. CLARK, P. O. BOX 11294, NORFOLK, VA, 23517, US

(21) Appl. No.: 11/586,037

(22) Filed: Oct. 25, 2006

(51) Int. Cl. G01B 3/10

(52) U.S. Cl. 33/770

(57) ABSTRACT

A tape measure marker device is attachable to a common tape measure blade. The marker device has a central body portion with a pair of downwardly depending legs, each with an inwardly facing flange that helps hold the marker device to the tape measure blade. The ends of the facing flanges are spaced apart and together with the underside of the two legs and the central body portion form an open cavity that is configured to receive a common tape measure blade. The convex underside of the central body portion is adapted to nest with the top face of the tape measure blade. In operation, the marker device is manually slid along the tape measure blade until a registration mark, which may be printed, embossed or engraved on the surface of the device, aligns with a point that is to be measured. The coplanar underside of the flanges on the device allows the marker device and the tape measure blade to lie directly against a device that is to be measured. In a preferred embodiment the marker device is constructed of a resilient transparent or translucent resilient so that the graduated indicia markings on the measuring tape can be seen through the device, and so that the legs of the device can temporarily be manually spread apart wide enough for insertion of the tape measure blade.

### BACKGROUND OF THE INVENTION

1. Field of the Invention

The present invention relates generally to carpentry tools. More particularly, the present invention relates to an improved tape measure attachment apparatus that can be used as a measurement marking gauge.

2. Description of the Prior Art

Standard tape measures include a length of tape wound on a spool with a spring return mechanism so that, after the tape is taken out of a housing, the spring return mechanism can automatically retract the tape into the housing. Many common tape measures are provided with a locking mechanism, typically a sliding button, which locks the tape for the purpose of reading the length of the deployed tape. Graduated indicia markings along the length of the tape function as a measuring scale. In most common tape measures, in order to provide strength to the unwound length of tape, and to keep the unwound length of tape in a straight line, and to aid in proper rewinding of the tape inside of the housing, the tape, itself, has a permanent concave curvature (as viewed from the indicia-side of the tape).

A very common use of tape measures is to take a measurement of a length of a reference structure (between, say, a first point and a second point), then to locate that same length on a work piece, then to mark that length on the work piece. After the work piece is so marked, some sort of operation (for example, cutting, machining, drilling, attachment to another piece, etc.) may be performed on the work piece at the marked location.

A prior method of performing the above described function typically involves the following steps. The free end of a tape measure is held at a first point on the reference structure. The tape is unwound (from the tape measure housing) along the reference structure until the tape extends from the first point to beyond the second point. When taking a measurement across a surface of a nominally flat reference structure, the exposed tape is usually laid directly against the surface of the reference structure. An operator then observes the location of the second point relative to the closest indicia thereto on the tape. In the event that the second point doesn't fall exactly in line with one of the tape's indicia, the operator will make a note of the two indicia that are closest to the second point, and make a mental interpolation of the point's position between those two indicia. The operator then makes a note of the overall length of the measurement as indicated from the measuring tape indicia markings.

Having made a note of the measured length, an operator then typically applies the tape measure to a work piece. A flange at the free end of the tape measure may, for example, be attached to an edge surface of the work piece. The extended tape is laid directly against a surface of the work piece, whereupon the operator makes a mark on the work piece (using a pencil or other marking device) adjacent to the measuring tape, at a point that more-or-less corresponds to the previously measured length.

A problem with this prior method of taking and transferring measurements, using common tape measures, is that there are several opportunities for disparities to be introduced between the actual length between points on the reference structure and the marked length on the work piece. For example, in the prior method errors can be introduced during the reading of the measurement between the first and second points on the reference structure. That is, the operator may simply misread the indicia marking on the tape.

Because of the concavo-convex curvature of the tape, itself, the indicia marking of the tape may not lie directly against the surface of the reference structure. Thus, either the tape must be manually bent in order to bring the edge of the tape into contact with the surface of the reference structure, or the measured point must be a finite distance from the indicia marking. Such bending can introduce error into the measurement, and such spacing of the edge of the tape away from the measured point can introduce parallax error into the measurement.

Also, whenever the location of the measured point (i.e., the second point on the reference structure) does not coincide precisely with an indicia marking on the tape, the operator has to make an approximation or a calculated interpolation of the distance between the measured points. Such approximation or calculated interpolation can introduce error into the measurement.

Also, because the operator must make a note of, and subsequently recall, the measured length (between points on the reference structure) there are two additional opportunities for error to be introduced into the measurement. Such errors could be introduced, for example, if the measurement were incorrectly noted or incorrectly recalled.

Error can similarly be introduced (i.e., due to interpolation, parallax or recall error) not only in the taking of a measurement, but also while transferring the measured distance to a work piece.

I addition, because it is often necessary (using the typical prior method) to simultaneously (a) secure the free end of the tape on the work piece, (b) hold the unwound length of the tape adjacent to the work piece, (c) hold a marking implement, (d) select a desired tape indicia marking corresponding to the recalled length, and (e) place a mark on the work piece at a position adjacent to the selected indicia marking, the operation can require more than two hands to accomplish all these operations simultaneously.

Various prior tape measure attachments have been proposed to aid in transferring measured marks to work pieces. For example, U.S. Pat. No. 6,804,898 shows a tape rule marking implement in which a support member is mounted onto the ruler blade and secured, by a screw fastener, to the tape rule housing. The support member of this prior device is designed to receive a marker implement for placing a mark on a work surface. A problem of this prior device is that it is bulky, has several parts, and involves fastening to the tape measure housing, and the bottom portion of the device inherently prohibits the (concavo-convex) tape from lying directly against a work piece.

U.S. Pat. No. 6,108,926 shows a tape measure with an anchor hook fastened to the free end of the tape. Although the anchor hook on this prior device may assist in securing the free end to certain types of work pieces, it does not aid in identifying the location along the tape at which a measured work piece is to be marked.

U.S. Pat. Nos. 6,996,915 and 6,497,050 and 4,890,393 each show a tape measure with a marking gauge attached intermediately along the length of the tape, with the gauge member being longitudinally slidable to a desired location along the tape. In each of these prior devices, a vertical face of the gauge member depends downwardly from the underside of the tape and is designed to engage an edge surface (as illustrated at FIG. 6 of U.S. Pat. No. 6,497,050; as illustrated at FIG. 6 of U.S. Pat. No. 6,996,915; and as illustrated at FIG. 1 of U.S. Pat. No. 4,890,393) of a work piece that is to be measured. None of these prior devices facilitates making a mark on a work piece at an intermediate location along the measuring tape; and, because of their downward depending appendages, none of these prior devices allows the measuring tape to lie directly against the work piece in the area directly beneath the appendage.

Furthermore, none of these prior attachment devices is designed to facilitate the taking of a measurement between two spaced apart points on a reference structure. Rather, these prior attachment devices are directed towards applying a known measurement to a work piece.

There is a need in the art for a device that can be used in conjunction with a common tape measure to take a measurement of a distance between two reference points, and then to accurately transfer that measured distance to a work piece, without the introduction of unacceptable measurement or data transfer errors.

### SUMMARY OF THE INVENTION

In view of the foregoing disadvantages inherent in the known tape measure devices now present in the prior art, the present invention provides an attachment for a common tape measure that facilitates the measurement of a distance between two reference points, and the accurate transfer of that measured distance to a work piece, and a method of using same.

Accordingly, it is an object of the present invention to provide a tape measure attachment device of the character described wherein the device can be attached to a common measuring tape without necessitating the use of tools or fasteners.

It is another object of the present invention to provide a tape measure attachment device of the character described that can be moved along a measuring tape to a selected position on the tape corresponding to a point whose location is to be measured.

It is another object of the present invention to provide a tape measure attachment device of the character described wherein the device temporarily stays affixed to the tape at the selected position along the tape, for transferal of a measurement to a work piece.

It is another object of the present invention to provide a tape measure attachment device of the character described wherein the device attaches to the measuring tape in a manner that does not inherently prevent the measuring tape from lying directly against a work piece in the vicinity of the attachment device.

It is another object of the present invention to provide a tape measure attachment device of the character described that can be constructed of a single piece of material.

It is another object to provide an embodiment of the present invention in which the attachment device is constructed of a resilient material, such as plastic.

It is another object to provide an embodiment of the present invention in which the attachment device has an index marking thereon, which index marking can be lined up with a point that is to be measured on a reference structure.

It is another object to provide an embodiment of the attachment device wherein an operator can read a measurement on the measuring tape corresponding to the distance to a point that is to be measured while the index marking on the attachment device is lined up with said point.

It is another object to provide an embodiment of the present invention in which the attachment device has a flat surface perpendicular to the length of the measuring tape, which flat surface can be used as a straight edge for transferring and marking a measured dimension onto a work piece.

In these respects, the tape measure attachment device according to the present invention substantially departs from the conventional concepts and designs of the prior art.

These, together with other objects of the invention, along with the various features of novelty that characterize the invention, are pointed out with particularity in the claims annexed to and forming a part of this disclosures. For a better understanding of the invention, its operating advantages and the specific objects attained by its uses, reference should be made to the accompanying drawings and descriptive matter in which there are illustrated a preferred embodiment of the invention and variations thereof.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 is a perspective view of a tape measure attachment device constructed in accordance with the present invention;

FIG. 2 is a front elevation of a tape measure attachment device constructed in accordance with the present invention;

FIG. 3 is a top view showing a tape measure attachment device in combination with a common measuring tape;

FIG. 4 is a perspective view showing a tape measure attachment device being used in combination with a tape measure to measure a distance on a work piece;

FIG. 5 is a perspective view of a modified embodiment of the invention showing a marker recess in the side of the attachment device; and,

FIG. 6 is a front elevation showing a modified tape measure attachment device constructed in accordance with the present invention.

### REFERENCE NUMERALS IN DRAWINGS

H Height of side of marking guide
P Plane of symmetry
T Measuring tape blade
W Work piece
10 Tape measure marking guide, general
12 Top face
14 First side wall
14a Inwardly facing surface of first side wall
16 Second side wall
16a Inwardly facing surface of second side wall
18 Central body portion
20 Front face
22 Underside of Central portion
24 First flange
24a Distal end of First Flange
24b Bottom surface of First Flange
26 Second flange
26a Distal end of Second Flange
26b Bottom surface of Second Flange
28 Cavity
30 Registration mark
32 Boss
34 Back face
36 Recess
40 Tape measure marking guide, modified, general
42 Underside of central portion
44 Left Flange
46 Right Flange
48 Left Side wall
50 Right Side wall

### DESCRIPTION OF THE PREFERRED EMBODIMENT

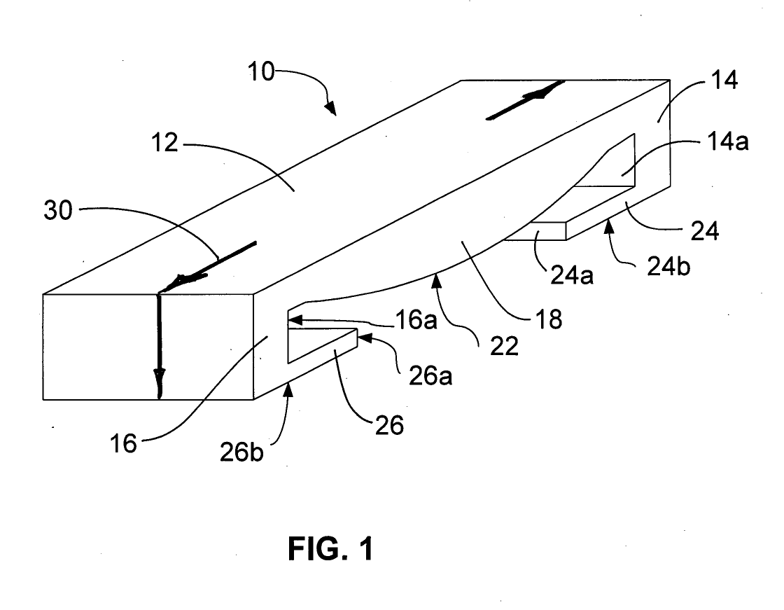

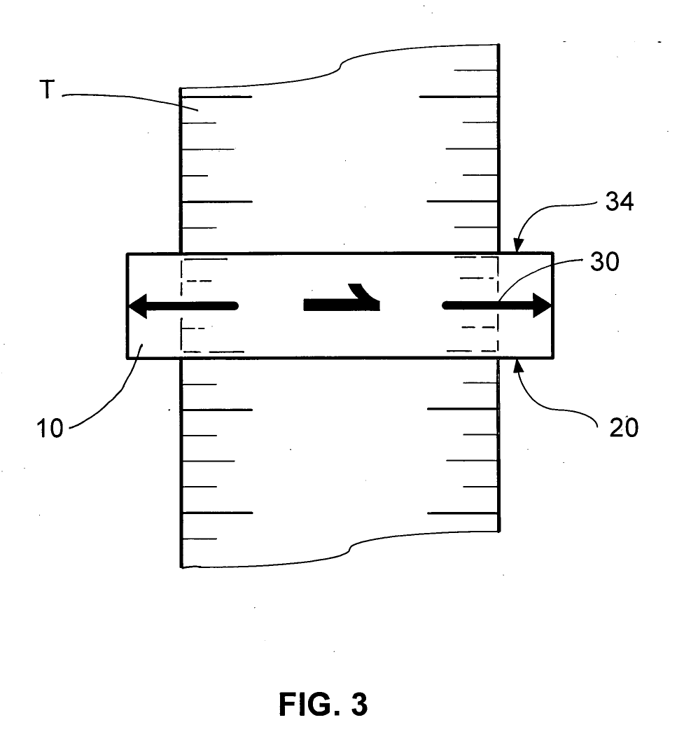

Referring to FIGS. 1 through 4, in which are shown a preferred embodiment of a tape measure marking guide 10 in accordance with the present invention: Marking guide 10 is designed to be operationally used in conjunction with, and attachable to, a common measuring tape blade (T), which may be normally retractably stored in a coiled condition within a tape measure casing, and which may be normally extracted in a substantially straight line from the tape measuring case, and which nominally has a concavo-convex transverse cross-section, and which has graduated indicia markings along its length to function as a measuring scale.

Marking guide 10 has opposing first 14 and second 16 side walls depending downwardly from a central body portion 18. Central body portion 18 has a top surface 12 and an underside surface 22.

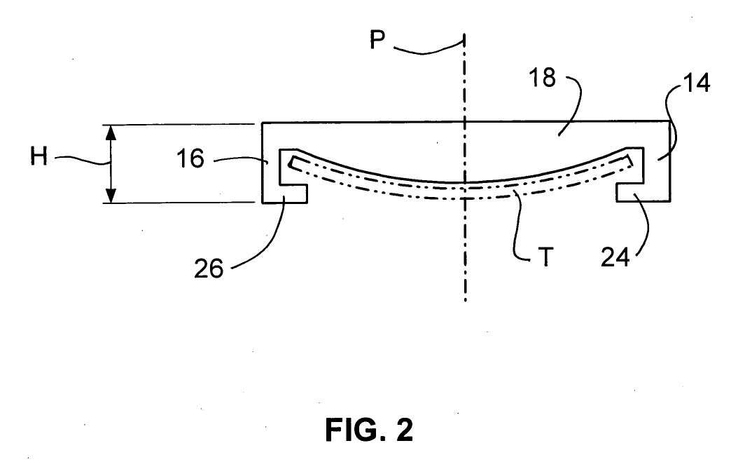

First 24 and second 26 flanges extend from, and are directed inwardly toward each other from, first 14 and second 16 side walls, respectively. The central body's underside 22, first 14 and second 16 side walls, and first 24 and second 26 flanges, combine to form a cavity 28 that is adapted to receive a common measuring tape blade (T). Preferably, cavity 28 is symmetric about a plane (P), as shown in FIG. 2.

In the preferred embodiment of the invention, underside surface 22 of central body portion 18 is convex. The radius of curvature of the convex underside surface 22 of central body portion 18 is preferably selected to substantially conform to the radius of curvature of a concave top surface of a common concavo-convex measuring tape blade (T), which may be used in conjunction with the device.

The inwardly facing surfaces 14a, 16a of first and second side walls 14, 16 of the marking guide 10 are preferably spaced apart at a distance that is approximately the same as the nominal width of measuring tape blade (T), such that when tape blade (T) is operationally inserted into cavity 28 of marking guide 10, it fits between the inwardly facing surfaces 14a, 16a of the first and second side walls 14, 16, respectively.

In the preferred embodiment of the invention, the distal ends 24a, 26a of first and second flanges 24, 26 are spaced apart at a distance that is less than the width of the measuring tape blade, but great enough to allow the tape blade (T) to be inserted into (or subsequently removed from) cavity 28 by temporarily bending either tape blade (T) or marking guide 10 (or both), as will be described more fully herein below.

By way of example only, for use with a common tape measure having a nominal 1 inch wide concavo-convex tape blade (T) and approximately 3/16 inch chord height, the radius of curvature of the convex underside surface 22 of central body portion 18 may be approximately 1 1/16 inches; the inwardly facing surfaces 14a, 16a of first and second side walls 14, 16 of marking guide 10 are spaced approximately 1 inch apart; and distal ends 24a, 26a of first and second flanges 24, 26 are spaced approximately ⅞ inch apart.

In the preferred embodiment of the invention, the height (H) of each of the side walls (14, 16) of marking guide 10, as measured from the top of the cavity-side of the sidewalls (14 and 16) to the bottom of the outside of the flanges (24 and 26, respectively), is approximately equal to the cord height of the concavo-convex tape blade (T) with which marking guide 10 is to be used.

By way of example only, for use with a common tape measure having a nominal 1 inch wide tape blade with approximately 3/16 inch chord height, the height (H) of each of the side walls (14, 16) is approximately 3/16 inch.

It will be appreciated that, because the height (H) of each sidewall (14, 16) is approximately equal to the chord height of the measuring tape blade (T) with which the device is to be used, it is possible to simultaneously place the bottom surfaces (24b, 26b) of both flanges (24, 26) and the bottom of the measuring tape blade (T) directly against a planar surface (such as a flat work piece (W)).

In the preferred embodiment of the invention a visible registration mark 30 is disposed on the top face 12 of the marking guide 10. In various embodiments of the invention, the registration mark 30 may, alternatively, be disposed on the top face 12 and extend to one or two opposing edges of the top face 12; or the registration mark 30 may be disposed on one or both of the side walls (14, 16) and extend to the bottom edge of the side wall(s) (14, 16); or the registration mark 30 may be disposed on any combination of these surfaces.

In the preferred embodiment of the invention, the registration mark 30 comprises a straight line printed on top face 12, oriented perpendicular to a side wall (12, 14) of the marking guide 10, and having the point of an arrowhead located at or nearly at an edge of the top surface, as shown in FIG. 1.

The tape measure marking guide 10 is preferably constructed of a transparent or substantially transparent material, such a polypropylene, such that both the registration mark 30 on the marking guide 10 and the graduated indicia markings along the measuring tape blade (T) are both visible at the same time by an operator when a measuring tape blade (T) is inserted into the cavity 28 of the device.

A preferred method of using a tape measure marking guide 10 constructed in accordance with the present invention to take a measurement from a reference structure and transfer same to a work piece is described. A common measuring tape blade (T) is extracted in a straight line from its tape measure case. The measuring tape blade (T) is inserted into the cavity 28 of the marking guide 10, as shown in FIGS. 2-4, with the graduated indicia markings of the tape blade facing the underside 22 of the central body portion 18 of the marking guide.

In the preferred embodiment of the invention, the distance between the distal ends 24a, 26a of the first and second flanges 24, 26 is nominally less than the width of the measuring tape blade (T). Thus, in order to insert the tape blade (T) into (or remove the tape blade (T) from) the cavity 28 it is necessary temporarily to pull distal ends 24a, 26a away from each other and/or compress the sides of the measuring tape blade. For this reason, the tape measure marking guide 10 is preferably constructed of a resilient material, such a polypropylene, so that the distal ends of the flanges 24, 26 can be temporarily pulled apart and then the device can recover its nominal shape when released.

Once the tape blade (T) has been inserted into cavity 28, flanges 24 and 26 hold the tape blade (T) and the marking guide 10 together, and the marking guide 10 can longitudinally slide along the length of the extracted measuring tape blade (T).

In order to take a measurement between two points on a reference structure, the free end of the measuring tape is held at the first point, and an intermediate section of the extended tape is placed near the second point. An operator then manually slides the marking guide 10 along the measuring tape blade (T) until the registration mark 30 on the marking guide becomes aligned with the second point. It will be appreciated that the distance between the free end of the measuring tape and the registration mark 30 constitutes a measurement of the distance between the first and second points on the reference structure.

Friction between the cavity walls of marking guide 10 and measuring tape blade (T) hold the marking guide at the selected position on the measuring tape blade. It will be appreciated that, in order to exert frictional forces to the measuring tape blade (T), two or more walls of the cavity 28 must be in contact with measuring tape blade (T). To facilitate such contact, in a preferred embodiment of the invention, the inwardly facing surfaces 14a, 16a of side walls 14, 16 are spaced apart at a distance that is no greater than the nominal width of the measuring tape blade (T). In this embodiment of the invention the inwardly facing surfaces 14a, 16a of side walls 14, 16 apply frictional forces to the edge of the measuring tape blade (T).

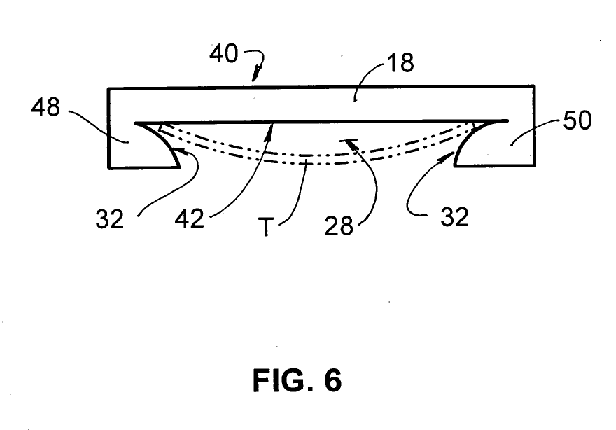

A modified embodiment of the invention 40 is illustrated in FIG. 6. In this modification of the invention, a boss 32 is provided on the cavity side of the left 48 and right 50 side walls of the device, as shown in FIG. 6. In this embodiment of the invention bosses 32 and underside surface 42 of central body portion 18 of the marking guide apply friction forces to the face(s) of the measuring tape blade (T) to hold the guide 40 in place while in operation. The boss 32 may be convex, as illustrated in FIG. 6, or may be of various other geometries. In addition, the boss 32 may extend to the underside surface 42 of the central body portion 18, as illustrated in FIG. 6, or, alternatively a gap (not shown) may be provided at the interior of each sidewall 48,50 between the boss 32 and the underside surface 42 of central body portion. Also, the underside surface 42 of central body portion 18 can be straight (i.e., planar), as illustrated in FIG. 6, rather than cambered or convex as described above with respect to the preferred embodiment of the invention. In this modified embodiment of the invention the marking guide 40 is preferably made of a fairly rigid transparent plastic material; and, in operation, a measuring tape blade may be inserted into cavity 28 by compressing the opposite sides of the measuring tape blade (T).

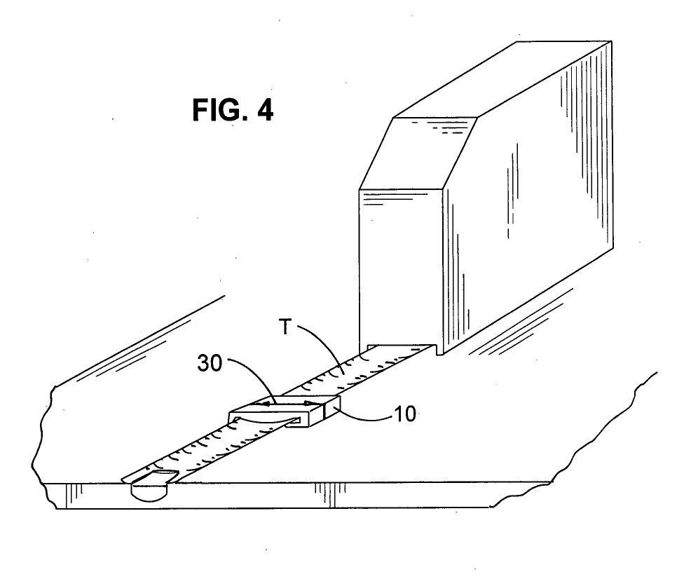

In order to transfer the measured distance between the first and second points on the reference structure to a work piece (W), the free end of tape blade (T) is secured at a first position on the work piece. The extended length of measuring tape blade (T), and the bottom surface 24b, 26b of the flanges 24, 26 of the attached marking guide 10, is laid against the work piece, as illustrated in FIG. 4. An operator may then make a mark, using a pencil, pen, scribe or similar device, on the work piece (W) at a point that is indicated by the registration mark 30 on the marking guide 10.

It will be appreciated that by using the marking guide 10 in the manner described herein above, a measurement can be accurately taken from between two points on a reference structure, and can be accurately transferred to a work piece.

In the preferred embodiment of the invention, the marking guide 10 is constructed of a transparent, or substantially transparent, material, such a polypropylene. Such construction allows an operator, not only to place the registration mark 30 in line with a measurement point, but it additionally allows the operator to read the graduated indicia markings on the measuring tape blade (T) through the central body portion 18 of the device.

In a modified embodiment of the invention, the central body portion 18, as well as other parts of the device, may be constructed of translucent or opaque materials, such as plastic, rubber, nylon or metal. In such embodiments of the invention that comprise opaque or translucent materials, measurements can be taken with respect to the front face 20 or back face 34 of the marking guide 10 (rather than with respect to a registration mark that is disposed intermediately between the front and back faces 20, 34 of the device).

In such modified embodiments of the invention, wherein measurements can be taken with respect to the front face 20 or back face 34 of the marking guide 10 (rather than with respect to a registration mark that is disposed intermediately between the front and back faces 20, 34 of the device), the front face 20 and/or the back face 34 of the marking guide 10 are preferably flat and are perpendicular to the plane (P) of symmetry of the device. In this embodiment of the invention (wherein the front and/or back faces 20, 34 of the device are oriented perpendicular to the plane (P) of symmetry of the device), not only can the front face 20 (or back face 34), itself, serve as a registration index, but it can additionally be used as a straightedge guide for a marking instrument (such as a pen, pencil, or scribe), by which a straight line can be marked on a work piece (W) at a measured distance from the free end of the measuring tape blade (T).

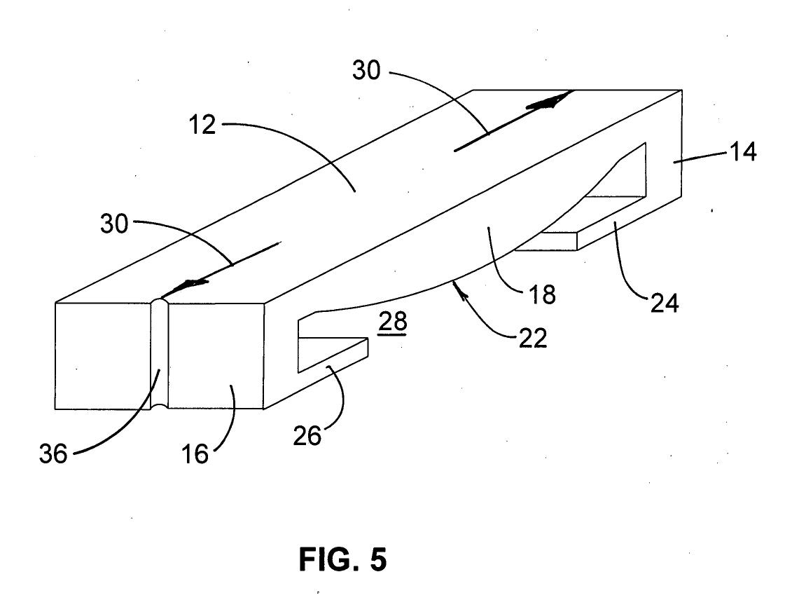

FIG. 5 illustrates a modified embodiment of the invention in which a recess or detent 36 is provided in the exterior of sidewall 16 in alignment with registration mark 30. Such a detent can be provided in either or both sidewalls 14, 16. In operation, a marking implement (such as a pen point, a pencil point, a scribe point or the like) can be placed by an operator into the detent in order to ensure precise marking of a work piece at the measured distance.

For purposes of explaining the construction and use of the present invention, terms such as “top”, “bottom”, “left” and “right”, and the like, are used herein to describe various elements of the invention as would be viewed by an observer facing the front 18 of the guide, such as shown at FIG. 1. It should be understood, however, that the present invention is designed to operate in virtually any orientation, and, is not limited to the orientation illustrated.

It will be appreciated from the above description of the construction and use of the present invention that, by sliding the marking guide 10 to the desired position on the measuring tape, it is not necessary that an operator observe or take note of the exact dimensional measurement that corresponds to the distance being measured. It will also be appreciated that, because the marking guide 10 can be positioned exactly at a desired measurement position and subsequently reproduced/transferred to a work piece, it is not necessary for an operator to make interpolative calculations for measurement points that lie between consecutive graduated indicia markings on the measuring tape.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Although the description above contains many specificities, these should not be construed as limiting the scope of the invention but as merely providing illustrations of some of the presently preferred embodiments of this invention. For example:

The registration mark on the device can be located on the top surface only, on either of the side walls, or on any combination thereof;

The registration mark can be printed onto, embossed onto, or engraved into a top or sidewall surface of the device;

The marking guide can be asymmetric with respect to plane (P);

The cavity 28 of the marking guide 10 can be constructed so as to receive and be operationally used with a flat rigid measuring device, such as a straight-edged ruler or yard stick, rather than with a retractable measuring tape blade;

The marking guide may, alternatively, be constructed of materials that are not transparent, such as plastic or rubber;

The top face 12 of the marking guide can be planar or curved, and, in a particularly useful modified embodiment, have a convex curve so as to magnify indicia markings on a tape measure blade directly adjacent to the marking guide;

A bubble-tube level may be attached to, or imbedded in, the central body portion of the device to facilitate accurate horizontal and/or vertical placement of the marking guide and the associated tape measuring blade;

The underside 22 of the central body portion 18 of the device may, alternatively, be other than convex shaped, and in particular may be planar or concave;

The height (H) of the side walls (14, 16) may, alternatively, be either greater or less than the chord length of the measuring tape blade with which the device is to be used;

The marking guide 10 can be constructed of a rigid material, in which construction it is necessary to compress the edges of the measuring tape blade in order to removably insert it into cavity 28;

A non-removable embodiment of the marking guide 10 can be constructed of a rigid material, in which construction the marking guide 10 can be assembled onto the measuring tape blade before a flange member is permanently affixed to the free end of the measuring tape blade;

The marking guide can be used in conjunction with linear devices other than measuring tape blades that have graduated indicia markings, provided the position of the marking guide is temporarily fixable relative to an identifiable reference mark on the linear device; and,

A series of multiple spaced apart marking guides 10 can simultaneously each be connected to a single measuring instrument, in the manner described herein above, in order to measure and/or transfer multiple measurements to a work piece;

Thus the scope of the invention should be determined by the appended claims and their legal equivalents, rather than by the examples given.

I claim:

1. A measurement marking guide device comprising:
a central body portion,
said central body portion having a top surface and an underside surface;
first and second side wall members extending downwardly from said central body portion on opposite sides of a plane passing through said central body portion,
said first side wall member having an interior surface;
and said second side wall member having an interior surface;
a first flange member extending from said first side wall member and directed towards said plane,
said first flange member having an interior surface and an exterior surface;
a second flange member extending from said second side wall member and directed towards said plane,
said second flange member having an interior surface and an exterior surface;
said first flange member having a distal end spaced apart from a distal end of said second flange member;
and wherein said underside surface of said central body portion, said interior surface of said first side wall member, said interior surface of said second side wall member, said interior surface of said first flange member and said interior surface of said second flange member form an open cavity.

2. The device according to claim 1,
wherein said open cavity is adapted to receive a measuring tape blade.

3. The device according to claim 2,
wherein said central body portion and said first and second side wall members are constructed of a resilient deformable material.

4. The device according to claim 3,
wherein said underside surface of said central body portion is convex and is substantially symmetric with respect to said plane.

5. The device according to claim 4,
wherein said exterior surface of said first flange member and said exterior surface of said second flange member are both substantially flat;
and wherein said exterior surface of said first flange member and said exterior surface of said second flange member are coplanar.

6. The device according to claim 5,
further comprising a registration mark on said top surface of said central body portion or on said first side wall member.

7. The device according to claim 6,
wherein said registration mark comprises an elongate mark on said top surface of said central body portion, said elongate mark on said top surface of said central body portion being oriented substantially perpendicular to said plane.

8. The device according to claim 6,
wherein said registration mark comprises an elongate mark on said first side wall member, said elongate mark on said first side wall member being oriented substantially parallel to said plane.

9. The device according to claim 6,
wherein said central body portion is constructed of a transparent or translucent material.

10. The device according to claim 9,
and further comprising a tape measure having a substantially straight tape measurement blade portion,
said tape measurement blade portion having a concavo-convex cross-section;
and said tape measurement blade portion having a longitudinal axis, and having first and second blade edges on opposite sides of said longitudinal axis,
and said tape measurement blade portion further having a maximum chord height measurable between a surface of said blade portion and a plane passing through said first and second blade edges;
and wherein a point at which said interior surface of said first side wall member connects to said underside of said central body portion defines an upper end of said first side wall member;
and wherein a first distance is measurable between said upper end of said first side wall member and said exterior surface of said first flange member;
and wherein said first distance is equal to or less that the maximum chord height of said measurement blade portion.

11. A measurement marking guide for attachment to a measuring tape blade, said measuring tape blade having a nominal blade width as measured between two opposite blade edges, said marking guide comprising:
a central body portion,
said central body portion having a top surface and an underside surface;
first and second side wall members extending downwardly from said central body portion on opposite sides of a plane passing through said central body portion,
a first flange member extending from said first side wall member and directed towards said plane,
said first flange member having an interior surface portion;
a second flange member extending from said second side wall member and directed towards said plane,
said second flange member having an interior surface portion;
said first flange member having a distal end spaced apart from a distal end of said second flange member at a distance less than said nominal tape width of said measuring tape;
and wherein said underside surface of said central body portion, said interior surface of said first flange member and said interior surface of said second flange member at least partially surround a cavity;
and wherein said cavity is adapted to receive a measuring tape blade;
and further comprising a registration mark on said top surface of said central body portion or on said first side wall member.
